(19) United States
(12) Patent Application Publication
(10) Pub. No.: US 2016/0041914 A1
(43) Pub. Date: Feb. 11, 2016

(54) Cache Bypassing Policy Based on Prefetch Streams

(71) Applicant: Advanced Micro Devices, Inc., Sunnyvale, CA (US)

(72) Inventors: Yasuko Eckert, Kirkland, WA (US); Gabriel Loh, Bellevue, WA (US)

(73) Assignee: Advanced Micro Devices, Inc., Sunnyvale, CA (US)

(21) Appl. No.: 14/451,929

(22) Filed: Aug. 5, 2014

(51) Int. Cl. G06F 12/08

(52) U.S. Cl. CPC G06F 12/0862; G06F 12/0888; G06F 2212/6046; G06F 2212/602

(57) ABSTRACT

Embodiments include methods, systems, and computer readable medium directed to cache bypassing based on prefetch streams. A first cache receives a memory access request. The request references data in the memory. The data comprises non-reuse data. After a determination of a miss in the first cache, the first cache forwards the memory access request to a cache control logic. The detection of the non-reuse data instructs the cache control logic to allocate a block only in a second cache and bypass allocating a block in the first cache. The first cache is closer to the memory than the second cache.

### BACKGROUND

1. Field

The present disclosure is generally directed to improving the performance and energy efficiency of caches.

2. Background Art

Many computer systems utilize the prefetching technique to improve the performance of accessing data in the memory. Prefetching occurs when a central processing unit (CPU) requests data from the memory before the CPU actually needs the data. Once the data comes back from the memory, a block in the cache is allocated to store the data. When the data is actually needed by the CPU, the data can be accessed by the CPU much more quickly from the cache than if the CPU had to make a request to the memory.

The cache system is often organized as a hierarchy of several cache levels. The lower level cache is closer to the memory than the upper level cache. The upper level cache is closer to the CPU and thus has faster access time for the CPU. But the upper level cache also has smaller capacity than the lower level cache. For example, in a three-level cache system, level 1 (L1) cache is the upper level cache to level 2 (L2) cache, and L2 cache is the upper level cache to level 3 (L3) cache. The CPU generally checks L1 cache first by issuing a demand request. If it hits in the L1 cache, the CPU proceeds at high speed by fetching the data from the L1 cache. If L1 cache misses, L2 cache is checked. If L2 cache misses, L3 cache is checked before external memory is checked. When the prefetching technique is applied to a multi-level cache system, conventional systems provide for allocating a block for the prefetched data at each level of the multi-level cache system on the fill path from the memory if there is a miss.

### BRIEF DESCRIPTION OF THE DRAWINGS/FIGURES

The accompanying drawings, which are incorporated herein and form part of the specification, illustrate the disclosed embodiments and, together with the description, further serve to explain the principles of the embodiments and to enable a person skilled in the pertinent art to make and use the embodiments. Various embodiments are described below with reference to the drawings, wherein like reference numerals are used to refer to like elements throughout.

FIG. 1A is a block diagram of a conventional method for prefetching streaming data in a system with three-level caches.

FIG. 1B is a block diagram illustrating prefetching non-reuse data with cache bypass policy in a system with three-level caches, in accordance with embodiments.

FIG. 2A is a block diagram illustrating sequential accesses streaming data, in accordance with embodiments.

FIG. 2B is a block diagram illustrating strided accesses streaming data, in accordance with embodiments.

FIG. 3 is a flowchart illustrating an exemplary prefetching process with cache bypassing policy for streaming data, in accordance with embodiments.

FIG. 4 is a flowchart illustrating an exemplary cache bypassing policy for streaming data by using a state maintained by the prefetcher, in accordance with embodiments.

FIG. 5 is a block diagram of an exemplary electronic device where embodiments may be implemented.

The features and advantages of the disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “embodiments” does not require that all embodiments include the discussed feature, advantage or mode of operation. Alternate embodiments may be devised without departing from the scope of the disclosure, and well-known elements may not be described in detail or may be omitted so as not to obscure the relevant details. In addition, the terminology used herein is for the purpose of describing particular embodiments only and is not intended to be limiting. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

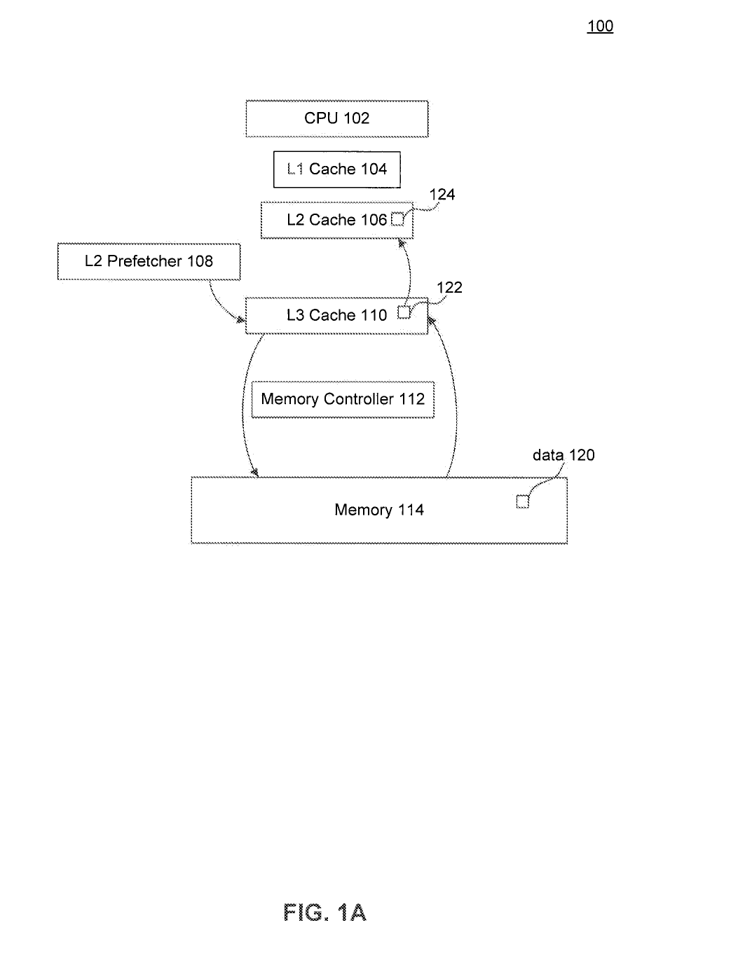

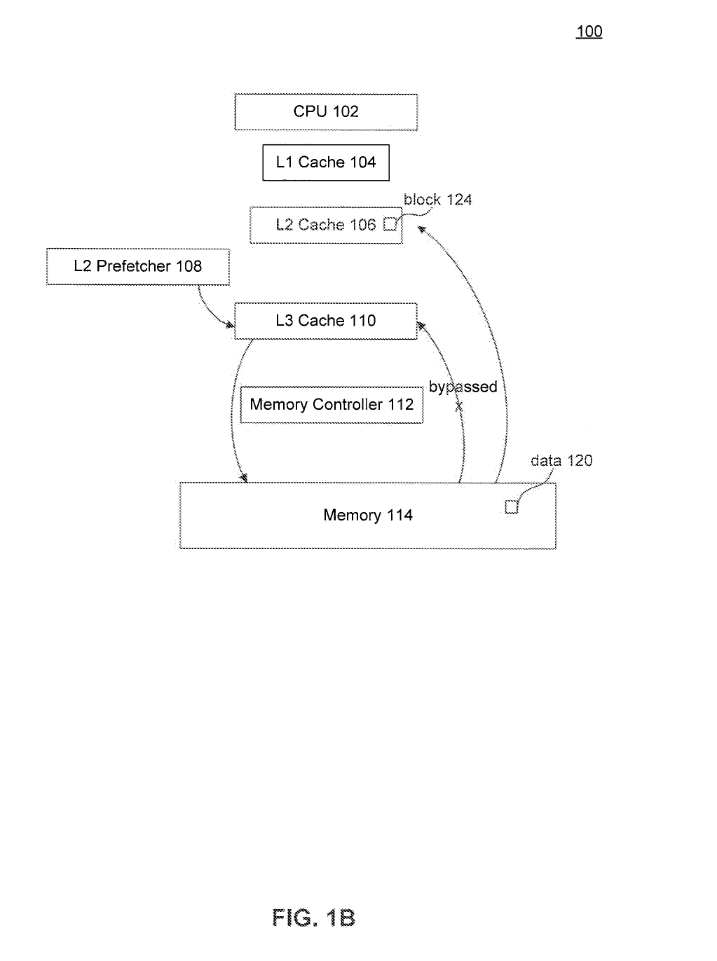

FIG. 1A is a block diagram illustration of a conventional method for prefetching streaming data in a system 100 with three levels of caches. In FIG. 1, an example heterogeneous computing system 100 can include one or more central processing units (CPUs), such as CPU 102. CPU 102 can include a commercially available control processor or a custom control processor. CPU 102, for example, executes the control logic that controls the operation of heterogeneous computing system 100. Although element 102 is depicted as a CPU and discussed herein as a CPU, such reference is by way of non-limiting example. Element 102 may be any component (e.g., a Graphics Processing Unit (GPU)) needing access to data stored on memory 114 having one or more intervening caches.

Heterogeneous computing system 100 can also include caches to improve performance. Caches can be used to store instructions, data and/or parameter values during the execution of an application on CPU 102. In this example, heterogeneous computing system 100 includes three levels of caches: L1 cache 104, L2 cache 106, and L3 cache 110. CPU 102 generally checks L1 cache 104 first; if it hits, CPU 102 proceeds at high speed by fetching data from L1 cache 104. If L1 cache misses, L2 cache is checked. If L2 cache misses, L3 cache is checked. If L3 cache misses, memory 114 is checked through memory controller 112. System 100 can also include prefetchers. Prefetchers may be used to prefetch data to a cache prior to when the data is actually requested by CPU 102. A prefetcher is often coupled to a cache. In this example, L2 prefetcher 108 is associated with L2 cache 106. L2 prefetcher 108 can issue a prefetch request to L3 cache 110 if L2 prefetcher 108 determines that data 120, which is stored in memory 114, should be prefetched.

A person skilled in the art will understand that prefetchers can be implemented using software, firmware, hardware, or any combination thereof. In one embodiment, some or all of the functionality of L2 prefetcher is specified in a hardware description language, such as Verilog, RTL, netlists, etc. to enable ultimately configuring a manufacturing process through the generation of maskworks/photomasks to generate a hardware device embodying aspects described herein. Also, although shown in FIG. 1A as located outside of any processors, L1 cache 104, L2 cache 106, L2 prefetcher 108 and L3 cache 110 may be implemented as a component of CPU 102.

Memory 114 can include at least one non-persistent memory, such as dynamic random access memory (DRAM). Memory 114 can store processing logic instructions, constant values, and variable values during execution of portions of applications or other processing logic. The term “processing logic,” as used herein, refers to control flow instructions, instructions for performing computations, and instructions for associated access to resources.

In a conventional system, shown in FIG. 1A, after L2 prefetcher 108 sends the prefetch request to L3 cache 110 to fetch data 120 stored in memory 114. If there is a miss in L3 cache 110 (i.e., data 120 is not stored in L3 cache 110), then the prefetch request is forwarded to the memory controller 112 and data 120 is fetched from memory 114. In addition, in the conventional system, data blocks at each level of the cache system are allocated to store the prefetched data 120. In this example, block 122 is allocated in the L3 cache 110 and block 124 is allocated in the L2 cache 106 so that data 120 can be copied from memory 114 to L3 cache 110 and L2 cache 106.

Prefetchers improve performance by reducing the average latency of load operations. However, allocating a block in a cache is useful only when the block will be used again; otherwise, the allocation wastes energy and cache capacity.

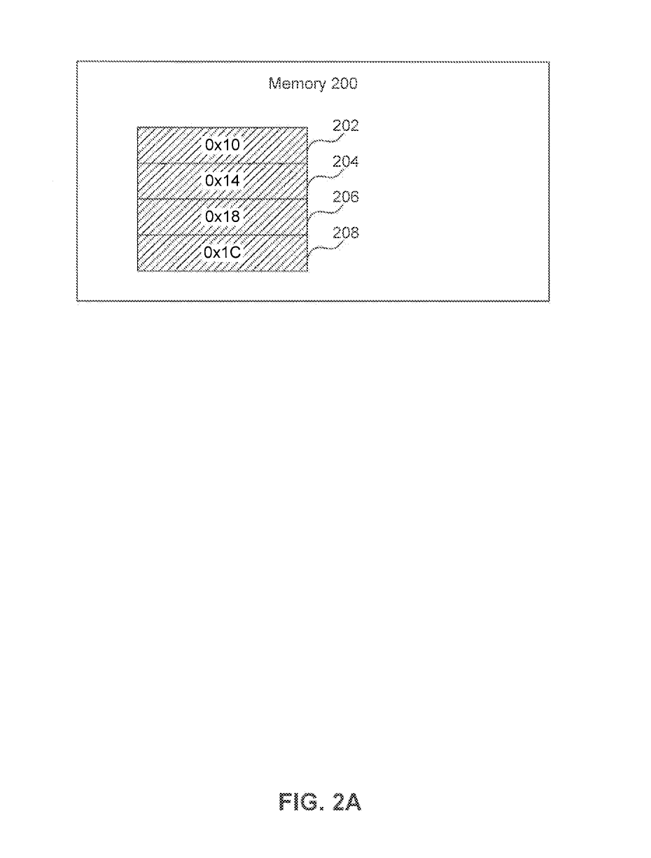

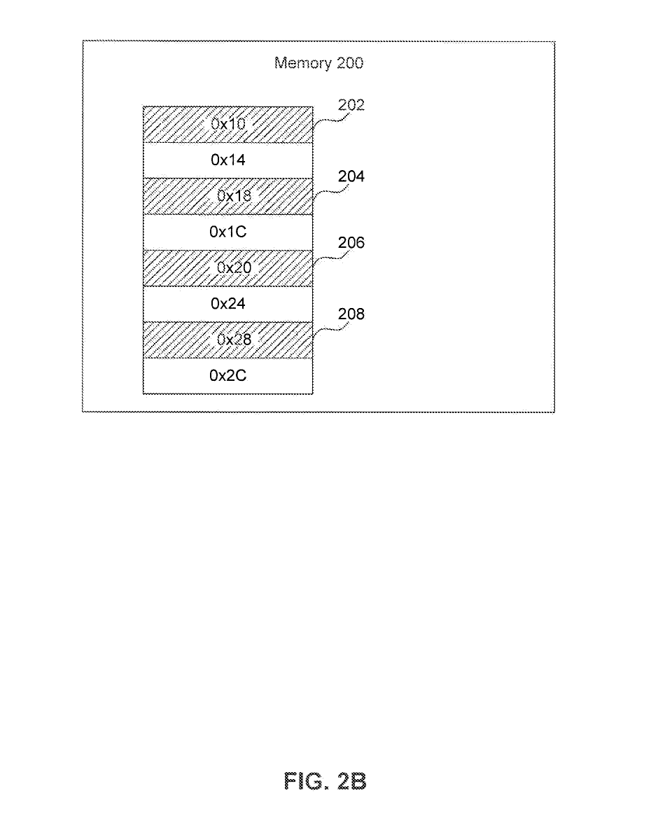

Streaming data are an example of zero-reuse data. Streaming data may be in sequential accesses pattern. FIG. 2A shows an example of sequential accesses. For example, in a 32-bit system, if L2 prefetcher 108 decides to prefetch data 202, data 204, data 206 and data 208 stored at memory addresses 0x10, 0x14, 0x18, 0x1C in memory 200 respectively, then data 202, data 204, data 206 and data 208 are streaming data in sequential accesses pattern.

Streaming data may also be in strided accesses pattern. FIG. 2B shows an example of strided accesses. For example, in a 32-bit system, if L2 prefetcher 108 decides to prefetch data 202, data 204, data 206 and data 208 stored at memory addresses 0x10, 0x18, 0x20, 0x28 in memory 200 respectively, then data 202, data 204, data 206 and data 208 are streaming data in strided accesses pattern.

Because streaming data is typically referenced only once, allocating blocks for stream data in the L3 cache wastes energy and cache space, likely evicting other cache lines that are still useful (i.e., those cache lines that would serve more hits in the near future).

FIG. 1B illustrates prefetching non-reuse data with cache bypass policy in a system with three-level caches, in accordance with some embodiments. Non-reuse data is the data that will not be re-used again (e.g., data for one-time use by the data requester). Streaming data is one non-limiting example of data for one-time use. Embodiments in FIG. 1B provide for reducing the inefficiency due to block allocation in caches for non-reuse data by leveraging data streams predicted by a prefetcher to dynamically making cache block allocation decision. With a more sophisticated prefetcher, the prefetcher may prefetch not only streaming data but also non-streaming data based on correlation of data accesses.

Prefetched data should bypass a lower-level cache only on streaming data, in accordance with an embodiment. For some embodiments, a non-reuse bit in a prefetch request is added, and the non-reuse bit is set if the prefetch request is for streaming data, which may be identified by examining the prefetching logic. On a fill path from the memory, a lower-level cache is bypassed only when the non-reuse bit is set; otherwise, the prefetched data are allocated in the lower-level cache as well. In some embodiments, L2 prefetcher 108 includes logic to identify streaming data and mark such data as non-reuse in the prefetch request.

In an embodiment, the prefetch request includes a non-use bit. If prefetcher 108 predicts streaming data, the non-reuse bit in the prefetch request is set by prefetcher 108 to indicate that the requested data is for one time use. When there is a miss in L3 cache 110, the prefetch request is forwarded to a cache control logic (not shown in FIG. 1B). In some embodiments, the cache control logic can be memory controller 112 (shown in FIG. 1B). When the prefetch request is forwarded to memory controller 112, memory controller 112 fetches data 120 stored in memory 114. However, the memory controller only allocates data block 124 in L2 cache 106 if the non-reuse bit in the prefetch request is set. Allocation of data block in L3 cache 110 is bypassed.

For illustration purpose, FIG. 1B shows the use of memory controller 112 to perform functionalities such as data block allocation and cache bypassing. However, a person skilled in the art will understand that those functionalities can be performed by other types of cache control logic. The cache control logic can be external to a cache (such as a memory controller). The cache control logic can also be contained by a cache. Each cache typically contains some control logic that: (a) records the request that missed in the cache. (b) sends the request to the next level of the cache/memory hierarchy, (c) is responsible for receiving the response from the next level of the cache/memory hierarchy, and (d) performs the installation/fill of the cacheline's data in the cache.

Also for illustration purpose, FIG. 1B uses a non-reuse bit in the prefetch request to trigger the cache bypassing feature. In some embodiments, the non-reuse bit need not be explicitly sent with the prefetch request to enable the cache bypassing feature. According to one embodiment where the bypassing is performed for a L3 cache, for example, when there is a miss in the L3 cache, the control logic in the L3 cache can make a local note that the requested data is predicted to be non-reusable. When the response comes back to the L3 cache, the control logic in the L3 cache can enable the cache bypassing feature by choosing not to install the requested data in the L3 cache based on the local note of predicted data non-reusability. In this way, cache bypassing operation can be performed locally in the L3 cache, without using the non-reuse bit in the prefetch request.

FIG. 1B shows the cache bypassing feature performed for the L3 cache. However, this feature is not limited to the L3 cache. Cache bypassing can be performed for other levels of cache as well. According to one embodiment where the bypassing is performed for a L2 cache (not shown in FIG. 1B), for example, when there is a miss in the L2 cache, the control logic in the L2 cache can make a local note that the requested data is predicted to be non-reusable. When the response comes back to the L2 cache, the control logic in the L2 cache can enable the cache bypassing feature by choosing not to install the requested data in the L2 cache based on the local note of predicted data non-reusability. In this way, cache bypassing operation can be performed locally in the L2 cache, without using the non-reuse bit in the prefetch request. According to another embodiment where the bypassing is performed for a L2 cache, the L2 prefetcher can set the non-reuse bit in the prefetch request to indicate the non-reusability of the data to the L3 cache and the memory controller.

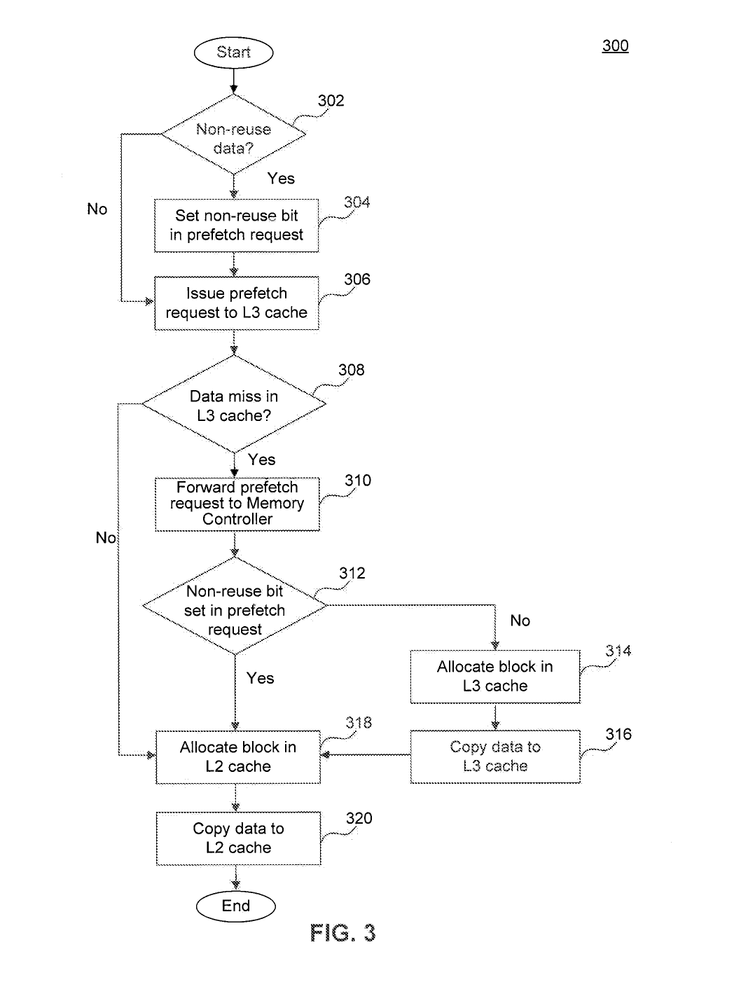

FIG. 3 illustrates a flowchart of a method 300 for an exemplary prefetching process with cache bypassing policy for non-reuse data. In one example, method 300 operates in a system as described in FIG. 1B. It is to be appreciated that method 300 may not be executed in the order shown or require all operations shown.

At operation 302, L2 prefetcher 108 determines whether data to be prefetched is nor-reuse data. Determination of whether data to be prefetched is non-reuse data can be based on whether the data is streaming data. Streaming data can be in sequential accesses pattern as well as in a strided access pattern. L2 prefetcher 108 includes such logic to identify streaming data.

If data to be prefetched is non-reuse data, then method 300 proceeds to operation 304. If data to be prefetched is not non-reuse data, then method 300 proceeds to operation 306.

At operation 304, L2 prefetcher 108 sets a field in the prefetch request to indicate that data to be prefetched is predicted to be non-reusable. According to an embodiment, a non-reuse bit is used to indicate non-reusability of the data.

At operation 306, L2 prefetcher 108 issues the prefetch request to L3 cache 110. The prefetch request includes reference to data to be prefetched, in addition to the non-reuse bit.

At operation 308, L3 cache 110 determines whether it has the requested data. In an embodiment, L3 cache 110 is the cache closest to memory 114. If there is a miss in L3 cache 110, the prefetch request is forwarded to memory controller 112 at operation 310.

At operation 312, memory controller 112 examines the non-reuse bit in the prefetch request, according to an embodiment. If the non-reuse bit is set, then memory controller 112 only allocates data block in L2 cache 106 at operation 318. At operation 320, data is copied from memory 114 to the block allocated in L2 cache 106. Block allocation in L3 cache 110 is bypassed.

If the non-reuse bit is not set, then memory controller 112 allocates a data block in L3 cache 110 at operation 314. At operation 316, memory controller 112 copies data from memory 114 to the block allocated in L3 cache. At operation 318, memory controller 112 allocates data block in L2 cache 106. At operation 320, data is copied from L3 cache 110 to the block allocated in L2 cache 106.

In some embodiments, the technique of bypassing block allocation in the lower-level cache can be performed conditionally.

The condition can be based on the length of the streaming data. If the prefetcher determines that a particular stream has short length, then it may be acceptable to fill the prefetched streaming data in the lower level cache because the pollution amount to the lower level cache is very small. In an embodiment, if L2 prefetcher 108 identifies that the streaming data has the length of 2 cache lines, then it will not set the non-reuse bit in the prefetch request. In another embodiment, if L2 prefetcher 108 identifies that the streaming data has the sufficient length of more than 2 cache lines, then it will set the non-reuse bit in the prefetch request.

The cache bypassing condition also can be based on any additional hints. In an embodiment, even though L2 prefetcher 108 predicts the streaming data, but other hints suggest that the streaming data will be re-used in the future, then L2 prefetcher 108 will not set the non-reuse bit in the prefetch request. Those hints provided by the prefetcher could be anything that may help with the fill/bypass decision. In one embodiment, aside from the predicted reusability of the stream data, an exemplary hint could be the accuracy or confidence level of the prefetcher as well. In another embodiment, if the prefetcher knows that the stream will be shared by multiple cores or multiple threads, then it might make sense to fill the prefetched data in the cache, too.

The embodiments described above utilize the prefetch request to instruct the memory controller to bypass block allocation in the lower-level cache for non-reuse data. However, the cache bypassing technique does not have to rely on prefetch requests. Other components of the system can make use of the prefetcher state to perform cache bypassing. For example, the prefetcher may have detected a stream, but has not yet reached a state of sufficiently high confidence to start issuing additional prefetch requests, or the current request rate may be too high to inject prefetch requests. Nevertheless, the prefetcher can maintain an internal state indicating the detection of the stream. In an embodiment, the CPU can examine the state in the prefetcher and set a non-reuse bit in the demand request if the state in the prefetcher indicates that streaming data has been detected. The non-reuse bit in the demand request can also instruct the memory controller to only allocate a block in the upper level cache and bypass block allocation in the lower level cache.

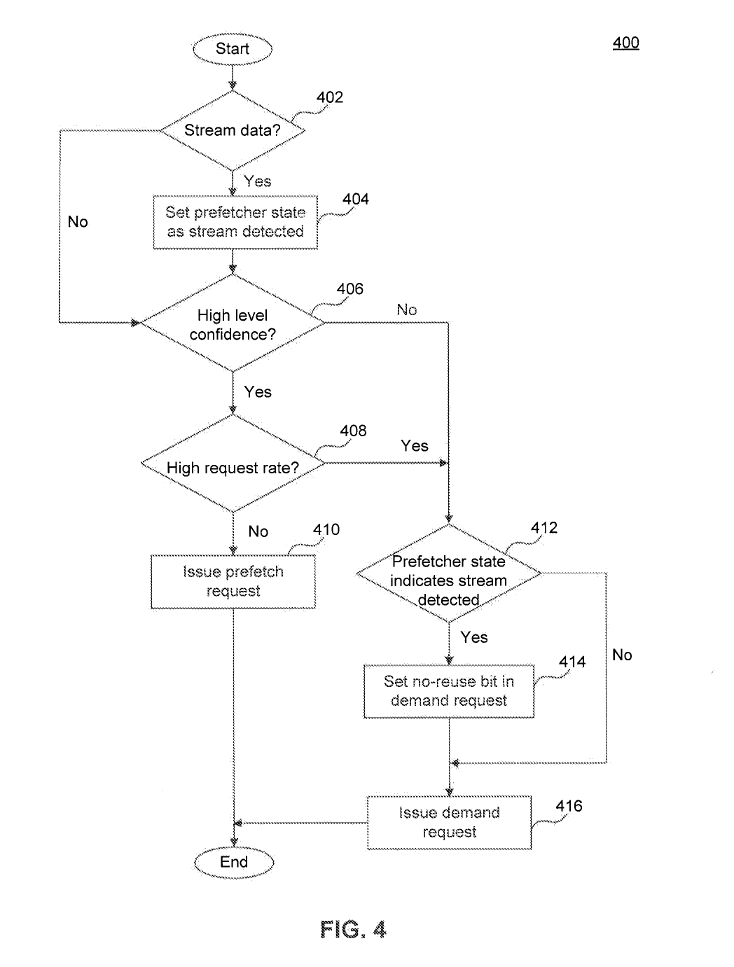

FIG. 4 is a flowchart illustrating a method 400 for an exemplary cache bypassing technique for streaming data by using a state maintained by the prefetcher, according to some embodiments.

In one example, method 400 operates in a system as described in FIG. 1B. Additionally, L2 prefetcher 108 maintains an internal state machine. The state machine can record whether streaming data has been detected. It is to be appreciated that method 400 may not be executed in the order shown or require all operations shown.

At operation 402, L2 prefetcher 108 determines whether data to be prefetched is streaming data. If data to be prefetched is not streaming data, then 400 proceeds to operation 406 to determine whether L2 prefetcher 108 has high level of confidence to issue additional prefetch requests.

If data to be prefetched is streaming data, then method 400 proceeds to operation 404. At operation 404, L2 prefetcher 108 sets its internal state to indicate that a stream has been detected. Then method 400 proceeds to operation 406 to determine whether L2 prefetcher 108 has high level of confidence to issue additional prefetch requests. It is up to the algorithm implemented in the prefetcher to decide when the confidence level of a detected stream is high enough. Many different metrics may be used, including but not limited to the length of the stream pattern detected, the number of hits or misses to the detected patterns. For example, the CPU has issued demand requests x10 and x14 to the cache so far. The prefetcher then starts detecting the access pattern and predicts the next access will be x18. However, the confidence level might be still too low (e.g., below 50%). Rather than issuing a prefetch request for x18, the prefetcher waits until the confidence level gets higher. Later, the CPU issues a demand request x18, which increases the confidence of the prefetcher for this data stream: x10, x14, and x18. The prefetcher starts issuing prefetch requests for x1C, x20, etc. at this point.

If the level of confidence is high enough, L2 prefetcher additionally checks whether the request rate is too high to inject prefetch requests at operation 408. If the request rate is not too high, at operation 410, L2 prefetcher 108 issues a prefetch request with the non-reuse bit set in the prefetch request (as described in method 300).

If either L2 prefetcher 102 has not reached a high confidence to issue additional prefetch requests or the request rate is too high, the prefetch request will not be issued by L2 prefetcher 102. However, in some embodiments, cache bypassing can still be performed by taking advantage of the internal prefetcher state. According to some embodiments, at operation 412, CPU 102 examines the internal state of L2 prefetcher 108 to see whether the state has been set to indicate detection of streaming data. At operation 414, if the prefetcher state indicates a stream, even though the prefetcher did not issue a prefetch request, CPU 102 sets a non-reuse bit in its demand request.

At operation 416, the CPU issues the demand request with the non-reuse bit in it. The non-reuse bit in the demand request, if set at operation 414, can also instruct the memory controller to only allocate a block in L2 cache 106 and bypass block allocation in L3 cache 110.

For illustration purpose, the above embodiments use a three-level cache hierarchy. The cache bypassing technique is applicable to any cache hierarchy, any number of cores, and any prefetcher types that include at least a streaming component.

Also for illustration purpose, the above embodiments use a prefetcher associated with a L2 cache, and the bypassing is performed at the L3 cache level. However, the cache bypassing technique described above can be applied to a prefetcher associated to any cache in a multi-level cache system and bypassing can also happen at any level of the multi-level cache system.

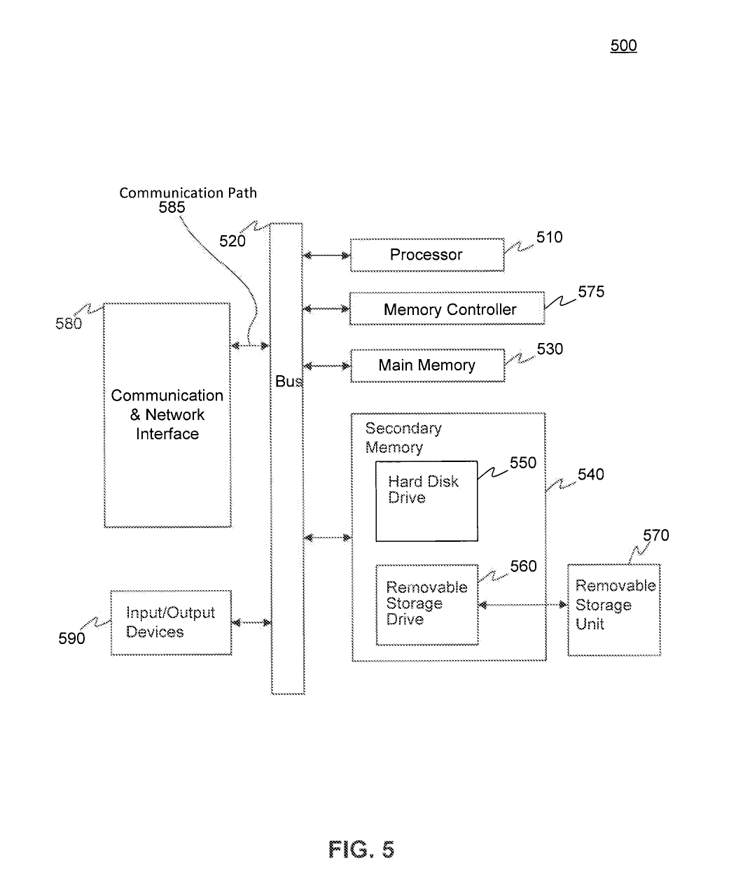

Various aspects of the disclosure can be implemented by software, firmware, hardware, or a combination thereof. FIG. 5 illustrates an example computer system 500 in which the contemplated embodiments, or portions thereof, can be implemented as computer-readable code. For example, the methods illustrated by flowcharts described herein can be implemented in system 500. Various embodiments are described in terms of this example computer system 500. After reading this description, it will become apparent to a person skilled in the relevant art how to implement the embodiments using other computer systems and/or computer architectures.

Computer system 500 includes one or more processors, such as processor 510. Processor 510 can be a special purpose or a general purpose processor. Processor 510 is connected to a communication infrastructure 520 (for example, a bus or network). Processor 510 may include a CPU, a Graphics Processing Unit (GPU), an Accelerated Processing Unit (APU), a Field-Programmable Gate Array (FPGA), Digital Signal Processing (DSP), or other similar general purpose or specialized processing units.

Computer system 500 also includes a main memory 530, and may also include a secondary memory 540. Main memory may be a volatile memory or non-volatile memory, and divided into channels. Secondary memory 540 may include, for example, non-volatile memory such as a hard disk drive 550, a removable storage drive 560, and/or a memory stick. Removable storage drive 560 may comprise a floppy disk drive, a magnetic tape drive, an optical disk drive, a flash memory, or the like. The removable storage drive 560 reads from and/or writes to a removable storage unit 570 in a well-known manner. Removable storage unit 570 may comprise a floppy disk, magnetic tape, optical disk, etc. which is read by and written to by removable storage drive 560. As will be appreciated by persons skilled in the relevant art(s), removable storage unit 570 includes a computer usable storage medium having stored therein computer software and/or data.

In alternative implementations, secondary memory 540 may include other similar means for allowing computer programs or other instructions to be loaded into computer system 500. Such means may include, for example, a removable storage unit 570 and an interface (not shown). Examples of such means may include a program cartridge and cartridge interface (such as that found in video game devices), a removable memory chip (such as an EPROM, or PROM) and associated socket, and other removable storage units 570 and interfaces which allow software and data to be transferred from the removable storage unit 570 to computer system 500.

Computer system 500 may also include a memory controller 575. Memory controller 575 includes functionalities of memory controller 112 in FIGS. 1A and 1B described above, and controls data access to main memory 530 and secondary memory 540. In some embodiments, memory controller 575 may be external to processor 510, as shown in FIG. 5. In other embodiments, memory controller 575 may also be directly part of processor 510. For example, many AMD™ and Intel™ processors use integrated memory controllers that are part of the same chip as processor 510 (not shown in FIG. 5).

Computer system 500 may also include a communications and network interface 580. Communication and network interface 580 allows software and data to be transferred between computer system 500 and external devices. Communications and network interface 580 may include a modem, a communications port, a PCMCIA slot and card, or the like. Software and data transferred via communications and network interface 580 are in the form of signals which may be electronic, electromagnetic, optical, or other signals capable of being received by communication and network interface 580. These signals are provided to communication and network interface 580 via a communication path 585. Communication path 585 carries signals and may be implemented using wire or cable, fiber optics, a phone line, a cellular phone link, an RF link or other communications channels.

The communication and network interface 580 allows the computer system 500 to communicate over communication networks or mediums such as LANs, WANs the Internet, etc. The communication and network interface 580 may interface with remote sites or networks via wired or wireless connections.

In this document, the terms “computer program medium,” “computer-usable medium” and “non-transitory medium” are used to generally refer to tangible media such as removable storage unit 570, removable storage drive 560, and a hard disk installed in hard disk drive 550. Signals carried over communication path 585 can also embody the logic described herein. Computer program medium and computer usable medium can also refer to memories, such as main memory 530 and secondary memory 540, which can be memory semiconductors (e.g. DRAMs, etc.). These computer program products are means for providing software to computer system 500.

Computer programs (also called computer control logic) are stored in main memory 530 and/or secondary memory 540. Computer programs may also be received via communication and network interface 580. Such computer programs, when executed, enable computer system 500 to implement embodiments as discussed herein. In particular, the computer programs, when executed, enable processor 510 to implement the disclosed processes, such as the steps in the methods illustrated by flowcharts discussed above. Accordingly, such computer programs represent controllers of the computer system 500. Where the embodiments are implemented using software, the software may be stored in a computer program product and loaded into computer system 500 using removable storage drive 560, interfaces, hard drive 550 or communication and network interface 480, for example.

The computer system 500 may also include input/output/display devices 490, such as keyboards, monitors, pointing devices, etc.

It should be noted that the simulation, synthesis and/or manufacture of various embodiments may be accomplished, in part, through the use of computer readable code, including general programming languages (such as C or C++), hardware description languages (HDL) such as, for example, Verilog HDL, VHDL, Altera HDL (AHDL), or other available programming and/or schematic capture tools (such as circuit capture tools). This computer readable code can be disposed in any known computer-usable medium including a semiconductor, magnetic disk, optical disk (such as CD-ROM, DVD-ROM). As such, the code can be transmitted over communication networks including the Internet. It is understood that the functions accomplished and/or structure provided by the systems and techniques described above can be represented in a core that is embodied in program code and can be transformed to hardware as part of the production of integrated circuits.

The embodiments are also directed to computer program products comprising software stored on any computer-usable medium. Such software, when executed in one or more data processing devices, causes a data processing device(s) to operate as described herein or, as noted above, allows for the synthesis and/or manufacture of electronic devices (e.g., ASICs, or processors) to perform embodiments described herein. Embodiments employ any computer-usable or -readable medium, and any computer-usable or -readable storage medium known now or in the future. Examples of computer-usable or computer-readable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nano-technological storage devices, etc.), and communication mediums (e.g., wired and wireless communications networks, local area networks, wide area networks, intranets, etc.). Computer-usable or computer-readable mediums can include any form of transitory (which include signals) or non-transitory media (which exclude signals). Non-transitory media comprise, by way of non-limiting example, the aforementioned physical storage devices (e.g., primary and secondary storage devices).

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described exemplary embodiments, but should be defined only in accordance with the following claims and their equivalents.

What is claimed is:

1. A method, comprising:
receiving a memory access request by a first cache, wherein the request references data in a memory;
detecting that the data comprises non-reuse data;
forwarding the memory access request, by the first cache, responsive to a determination that the data does not exist in the first cache; and
allocating, by a cache control logic, a block in a second cache based on the detecting of the non-reuse data to bypass allocating a second block in the first cache, wherein the first cache is closer to the memory than the second cache.

2. The method of claim 1, wherein the detecting further comprises:
detecting that the request indicates that the data comprises non-reuse data.

3. The method of claim 1, further comprising:
making a local note, by a cache-miss control logic associated with the first cache, that the data comprises the non-reuse data;
instructing the first cache to bypass allocating a second block in the first cache based on the local note.

4. The method of claim 1, further comprising:
copying the data in the memory to the block in the second cache.

5. The method of claim 1, further comprising:
identifying that the data comprises streaming data.

6. The method of claim 1, wherein the memory access request comprises a prefetch request indicating that the data comprises the non-reuse data based on a criteria of a streaming data having sufficient length.

7. The method of claim 1, wherein the memory access request comprises a prefetch request indicating that the data comprises the non-reuse data responsive to not receiving a hint indicating reusability of a streaming data.

8. The method of claim 1, wherein the memory access request is a demand request indicating that the data comprises non-reuse data according to a state in a prefetcher, the demand request instructing the cache control logic to allocate a block only in the second cache.

9. The method of claim 1, wherein the memory access request indicates that the data comprises non-reuse data by setting a non-reuse bit in the memory access request.

10. A system, comprising:
a memory;
a first cache, configured to:
receive a memory access request by a first cache, wherein the request references data in a memory,
detect that the data comprises non-reuse data, and
forward the memory access request responsive to a determination that the data does not exist in the first cache;
a second cache, wherein the first cache is closer to the memory than the second cache;
a cache control logic, configured to:
allocate a block in a second cache based on the detecting of the non-reuse data to bypass allocating a second block in the first cache, wherein the first cache is closer to the memory than the second cache.

11. The system of claim 10, wherein the first cache is further configured to:
detect that the request indicates that the data comprises non-reuse data.

12. The system of claim 10, further comprising:
a cache-miss control logic associated with the first cache, configured to:
make a local note that the data comprises the non-reuse data;
instruct the first cache to bypass allocating a second block in the first cache based on the local note.

13. The system of claim 10, wherein the cache control logic is further configured to:
copy the data in the memory to the block in the second cache.

14. The system of claim 10, further comprising:
a prefetcher, configured to identify that the data comprises streaming data.

15. The system of claim 10, wherein the memory access request comprises a prefetch request indicating that the data comprises non-reuse based on a criteria of a streaming data having sufficient length.

16. The system of claim 10, wherein the memory access request comprises a prefetch request indicating that the data comprises non-reuse data responsive to not receiving a hint indicating reusability of a streaming data.

17. The system of claim 10, wherein the memory access request is a demand request indicating that the data comprises non-reuse data according to a state in a prefetcher, the demand request instructing the cache control logic to allocate a block only in the second cache.

18. The system of claim 10, wherein the memory access request indicates that the data comprises non-reuse data by setting a non-reuse bit in the memory access request.

19. A computer-readable medium having instructions stored thereon, execution of which causes operations comprising:
receiving a memory access request by a first cache, wherein the request references data in a memory;
detecting that the data comprises non-reuse data;
forwarding the memory access request, by the first cache, responsive to a determination that the data does not exist in the first cache; and
allocating, by a cache control logic, a block in a second cache based on the detecting of the non-reuse data to bypass allocating a second block in the first cache, wherein the first cache is closer to the memory than the second cache.

20. The computer-readable medium of claim 19, wherein the detecting further comprises:
detecting that the request indicates that the data comprises non-reuse data.
